(19) United States
(12) Patent Application Publication
(10) Pub. No.: US 2007/0001444 A1
(43) Pub. Date: Jan. 4, 2007

(54) Cover assembly for a guide loop

(75) Inventors: Paul M. Smith, Davison, MI (US); Lyle W. Dunham, Madison Heights, MI (US)

Correspondence Address: FITCH EVEN TABIN AND FLANNERY, 120 SOUTH LA SALLE STREET, SUITE 1600, CHICAGO, IL, 60603-3406, US

(73) Assignee: Takata Seat Belts, Inc.

(21) Appl. No.: 11/172,334

(22) Filed: Jun. 30, 2005

(51) Int. Cl. B60R 22/00

(52) U.S. Cl. 280/808

(57) ABSTRACT

A cover assembly for a seat belt guide loop is disclosed having a first, outer cover portion connected by an elongate, thin connector member such as a tether with a second, inner cover portion. The outer cover portion is mounted to the vehicle via a bolt that pivotally mounts and anchors the guide loop. The head of the bolt is left exposed for a torque test or the like; and, then the tethered inner cover is assembled to the outer cover by a snap fit of one to the other. In one form, the tether may be integrally attached to one of the cover members and manually connected by an enlarged free end to the other cover member to tether the cover members together. The tether is hidden from view within the assembly cover portions after cover assembly. In another form, the tether may be a discrete part that is later connected to each of the respective cover portions.

### FIELD OF THE INVENTION

This invention relates to a cover assembly, such as a trim cover for a seat belt guide ring or loop often called a D-ring assembly.

### BACKGROUND OF THE INVENTION

The provision of web guides or so-called D-rings are primarily used to support and to guide a shoulder belt portion of a safety belt relative to an occupant's shoulder and many of the web guides are adjustably mounted so that the position relative to the occupant's shoulder may be changed by the occupant. Typically, the web guide is rotatably mounted to turn about a pivot axis at a bolt fastener which secures the pivotally mounted web guide or D-ring to the vehicle either directly or indirectly through an adjustable slide mechanism or the like to the vehicle structure. The bolt head is covered by the cover assembly to prevent a direct impact of a vehicle's passengers head at the time of an accident and for aesthetic reasons. In the usual installation procedure, this bolt and a first or outer cover portion are installed leaving the head of the bolt to be exposed for a later torque test. After the torque audit, a second cover part is assembled by a snap-fitted interconnection to the first part to cover the head of the bolt. Typically, in prior art constructions, these cover portions have been integrally joined by an integral hinge or living hinge and the cover portions are snap fitted together after the torque test of the bolt which often occurs toward the end of the production line. A typical D-ring cover used in integral hinges between the first cover portion and second cover portion are shown in U.S. Pat. Nos. 4,955,639; 5,207,452; 5,601,311 and 5,863,071.

An advantage of the living hinge cover is that both cover portions can be shipped as one unit by the supplier to an auto manufacturer's assembly plant. Further, during assembly, two separate containers for two separate parts are rendered unnecessary, which also reduces the likelihood that bolt torque testing will not occur before the cover is snap-fit together. A disadvantage of the living hinge cover is that the living hinge connection is often visible and is not hidden from view. Another disadvantage with using an integral or living hinge is that the hinge is a thin membrane of plastic material that may degrade to the point where the vehicle owner can see a whitening or cracking of the hinge material. Thus, there is a need for a new and improved cover assembly for D-rings, particularly where there is to be a subsequent torque test of the bolt assembly.

### SUMMARY OF THE INVENTION

In accordance with one aspect of the present invention, there is provided a new and improved cover assembly for a seat belt guide loop having a first cover portion secured with a fastening bolt, which is to be later torque tested, and has a connected or tethered second cover portion, which after the torque testing, can be assembled with the first cover portion to cover the head of the bolt. This is achieved in the preferred embodiment by a tether which readily bends and loosely hangs or dangles the second cover portion next to the D-ring such that the latter can be readily secured into an assembled position with the first cover portion after the torque testing operation.

The first cover portion will typically be bolted, either directly or indirectly, to a vehicle pillar for instance so it is outboard relative to the second cover portion loosely connected thereto, as by the flexible tether. Accordingly, the terms inner and outer refer to the relative location of the cover potions to each other as either being inboard or outboard relative to the other cover portion in the passenger compartment.

In accordance with another aspect, the tether is an elongated, thin piece of plastic which can be hidden within the assembled cover portions so as not to be visible after the cover assembly has been completed. In one embodiment, the tether is positioned in a receptacle therefor in one of the cover portions at the time of final assembly of the cover portions. In another form, the tether is received in a receptacle in each of the cover portions.

In accordance with a further aspect, the tether allows the first and second cover portions to be shipped as a connected, partially assembled cover assembly and thus as one unit to the vehicle assembly plant.

In accordance with a further aspect, the tether may be integrally attached to one of the cover portions, which is molded separately from the other cover portion, and a free end of the tether may be manually secured or attached to the other cover portion. In a preferred embodiment, the tether is integrally molded with and attached to a first cover portion and the tether has an enlarged free end, such as in the shape of an arrow or V, for being inserted through an opening into a box or the like on the other cover portion thereby tethering the cover portions to one another.

In accordance with a further aspect, the tether may be a separate part, that is a discrete part, from both the first cover and second cover portions, and the tether is then connected to each of the respective cover portions.

In accordance with another aspect, there is provided a seat belt guide loop assembly having a seat belt guide loop that is pivotally mounted on a bolt that is covered by a cover assembly having a plurality of cover portions joined by a tether.

### BRIEF DESCRIPTION OF THE DRAWINGS

FIG. 1 is a perspective view of a seat belt system having a D-ring assembly installed in position with a cover covering a head of a bolt used for securing the D-ring in position;

FIG. 2 is a perspective view prior to the final assembly of the inner or upper, dangling cover portion to an outer or lower cover portion prior to the torque testing of the bolt;

FIG. 3 is an enlarged perspective view showing the assembled cover with the tether hidden inside;

FIG. 4 is an enlarged view similar to FIG. 3 prior to the final assembly with the inner cover portion being tethered to the outer cover portion;

FIG. 5 illustrates a D-ring assembly with the outer cover portion prior to tethering the inner cover portion to the outer cover portion;

FIG. 6 is a front elevational view of a preferred cover assembly showing the inner cover portion and a slide actuator;

FIG. 7 is a rear elevational view of the cover assembly shown in FIG. 6 with the outer cover portion removed;

FIG. 8 is a side elevational view showing the outer cover portion having a tether for connection to the inner cover portion;

FIG. 9 is a side elevational view showing the tether being attached to the inner cover portion;

FIG. 10 is a side elevational view illustrating the outer and inner cover portions being assembled by sliding interlocking portions together with the D-ring removed for clarity;

FIG. 11 is a partially broken away view taken along the directional arrows 11-11 in FIG. 6 and showing the interior of the assembled cover portions with the tether being hidden from view;

FIG. 12 is an enlarged, partial cross-sectional view of an arrowhead on the tether movable into and through an opening in a box shaped receptacle on the inner cover portion;

FIG. 13 is a view similar to FIG. 12 but showing the arrow further positioned within the interior of the inner cover portion;

FIG. 14 is an enlarged view showing sliding of the interlocking portions toward their engaged position of the upper and lower cover portions;

FIG. 15 is a view similar to FIG. 14 showing the cover interlocking portions snap fit together;

FIG. 16 is a view taken along line 15-15 of FIG. 15 showing the interfering engagement between the snap fit interlocking portions;

FIG. 17 is a diagram of a method of assembling a tethered D-ring cover assembly in accordance with one aspect of the invention;

FIG. 18 is a perspective view of a tether formed separately from either of the cover portions; and

FIG. 19 is an elevational view showing opposite ends of the tether being connected to the cover portions.

### DETAILED DESCRIPTION OF THE PREFERRED EMBODIMENTS

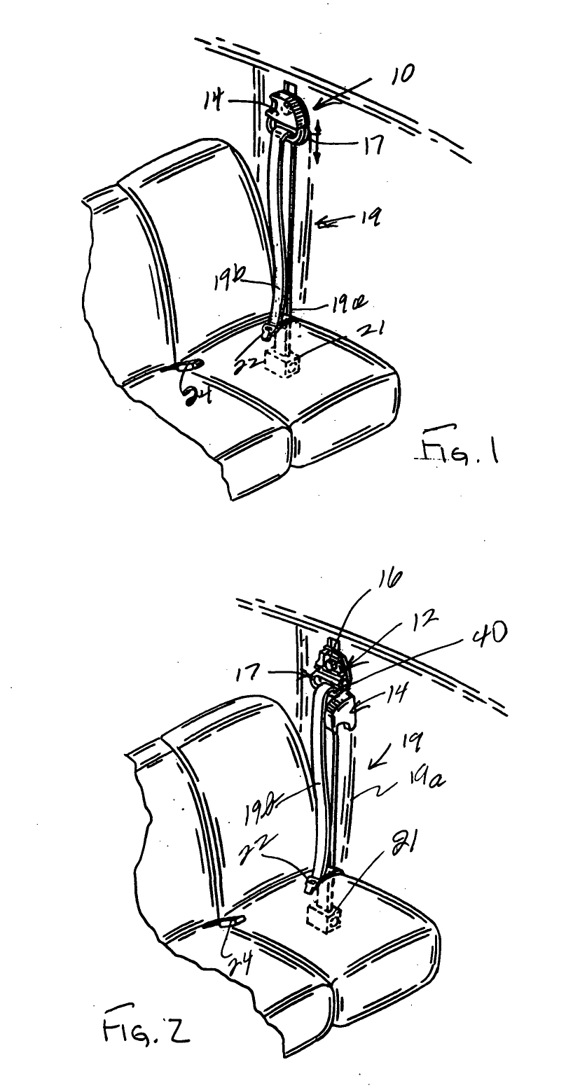

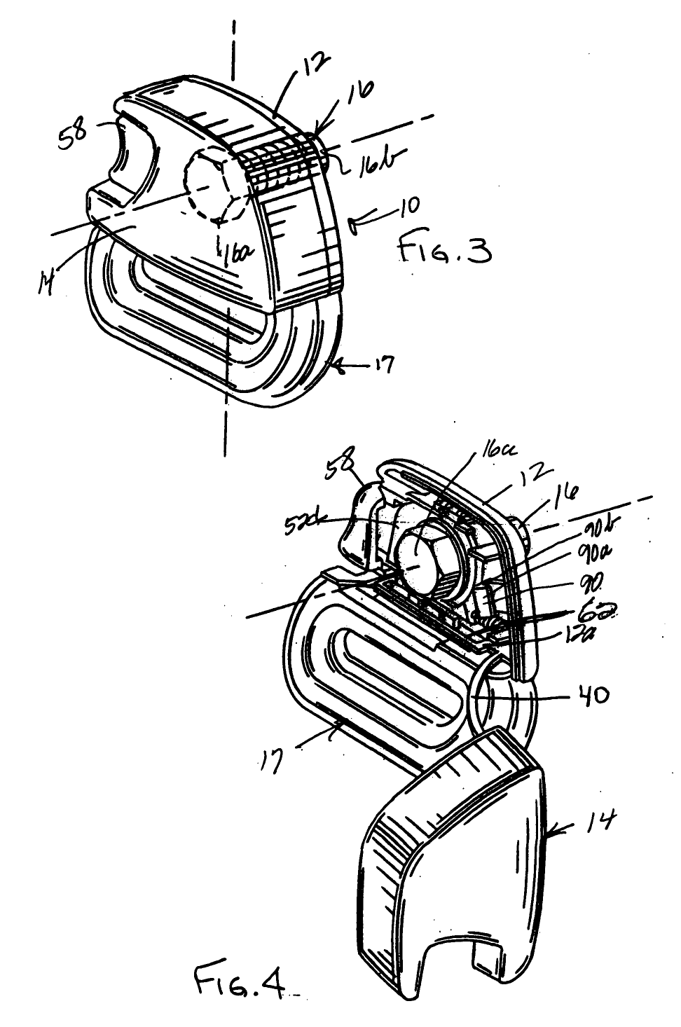

As best seen in FIGS. 1 and 2, this illustrated embodiment comprises a cover assembly 10 having an outer or lower cover portion 12 and an inner or upper cover portion 14 which are to be assembled to cover a bolt head 16a of a bolt 16 of a D-ring assembly or mechanism 17 in a seat belt system 19. The illustrated seat belt system of FIGS. 1 and 2 has a retractor or anchor 21 with an upwardly extending belt portion 19a and a shoulder portion 19b located on opposite sides of the D-ring assembly. A slidable tip or tongue plate 22 is slidably mounted on the seat belt for insertion into locking engagement with a seat belt buckle 24 to provide a typical 3-point seat belt system. The bolt 16 may be directly fastened to a frame or structural member of a vehicle such as a pillar thereof or as illustrated, fastened to a D-ring height adjusting mechanism which is in turn secured to the pillar. After installing the bolt and testing it for torque, the inner cover portion 14 is placed over the bolt head 16a to cover it and to provide head protection against a head impact therewith at the time of an accident. Usually, the first and second cover portions are snap fit together to a closed or final assembled position such as shown in FIGS. 1 and 3.

In some instances in the past, a distinct inner cover has been prematurely snap-fit to the separate outer cover prior to torque testing; and then the inner cover must be unfastened or detached to allow testing of the torque load. The inner and outer cover portions are then snap-fit together again to complete the cover assembly after the torque testing of the bolt. However, this initial snap-fitting and detaching of the cover parts together can undesirably weaken the strength or destroy the snap-fit connection. Prior art cover assemblies developed to address this problem, such as disclosed in the aforementioned patents, utilize an integral or living hinge design and the problems with that is that the hinge may degrade to the point of whitening or cracking which could be apparent to the customer. Also the problem is that the living hinge is generally not hidden and is in view of the customer.

In accordance with the present invention, the inner cover portion 14 is connected to the outer cover portion 12 by an elongate connector preferably in the form of tether 40 so that the inner cover portion may be loosely arranged relative to the outer cover portion. The tether 40 can be similar to a rope cord or other type of fastening device that would connect the parts together without there being an integral hinge or the like. As will be explained in detail hereinafter, the preferred tether 40 is a small, thin, elongated piece of plastic which can be inserted within the finished cover assembly and hidden entirely from view.

Another advantage of such tethered covers is that they can be shipped as one unit to the customer's final assembly plant for use that allows the manufacturer to install the D-ring assembly 17 and to conduct torque audits on the bolt 16 without first having to remove the D-ring inner cover portion 14. Thus, in the preferred embodiment there is a provided a fully assembled, tethered cover assembly 10 without any visible tether to be seen by a passenger in the vehicle.

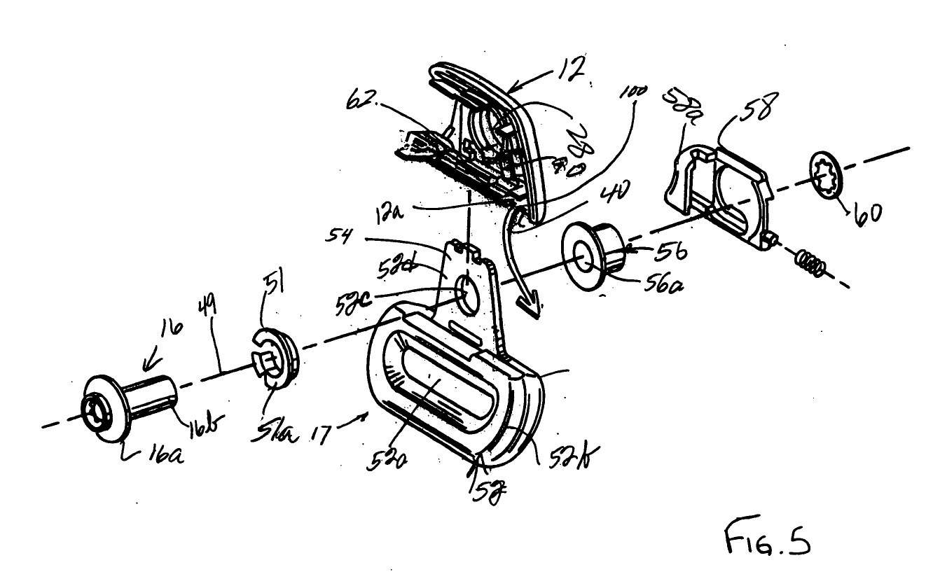

In the preferred embodiment illustrated in FIG. 5, the outer cover 12 has an integral tether 40 fastened to and integral with its sidewall 12a; and the tether is preferably in a narrow thin strip of molded plastic which terminates in an outer enlarged free end 42 for locking connection with the inner cover portion 14. The preferred enlarged end 42 is in the form of the shape of an arrow having a point or end 44 for insertion into an entrance opening 46 in box 45 in the inner cover to tether the inner cover portion 14 to the outer cover portion 12 as best seen in FIG. 9. When in the position of FIG. 9, the enlarged arrow end 42 of the tether 40 is inserted into the opening 46 in the outer part so once the arrow end is inserted, the two parts become a connected, partially assembled or tethered single unit, in essence, for shipping and assembly purposes.

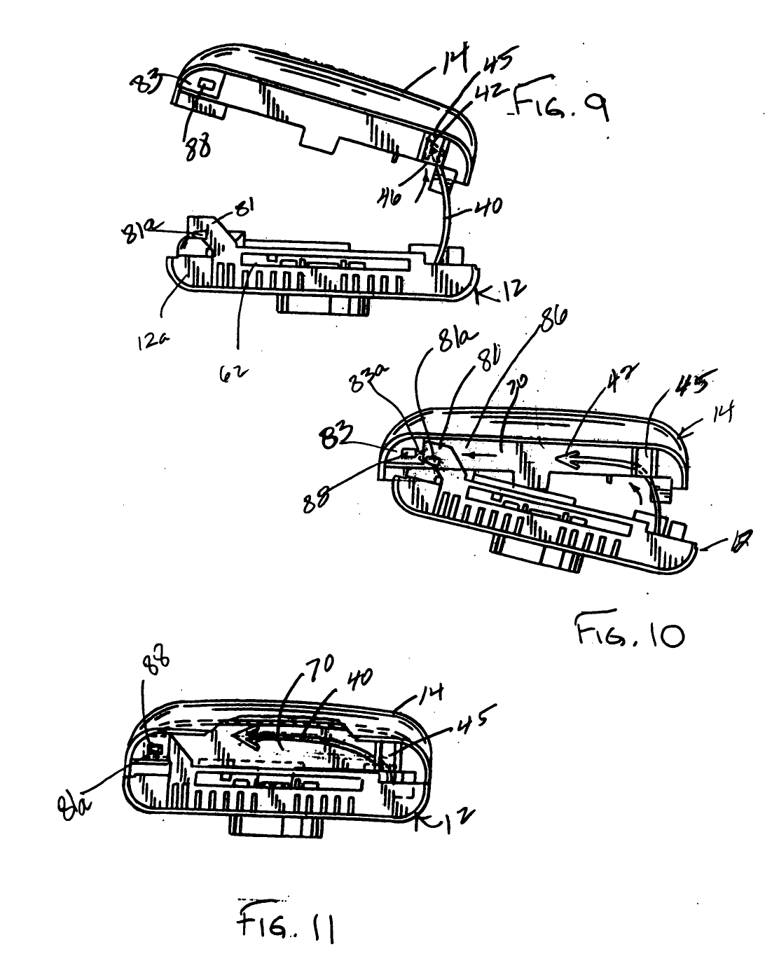

In accordance with an important aspect, and as best seen in FIGS. 10 and 11, once the enlarged arrowhead 44 is received in a receiving box 45 in the inner cover 14 it is then free to travel to the left as viewed in FIGS. 9-11 to be hidden from view within the interior of the inner cover portion 14.

Referring now in greater detail to the illustrated embodiment, there is shown in FIG. 5 a D-ring assembly which includes the bolt 16 having the bolt head 16a and a shank 16b which is adapted to be inserted through openings in several assembled components or elements of the outer cover, all of which are assembled and retained on the bolt by a bolt retainer 60 which is the last element placed on the bolt, as shown in FIG. 5. The bolt shank 16b is inserted through a first element which is a cylindrical, collared silencer member 51 which serves to make for quieter operation. The silencer member has a central opening to receive the bolt shank and has a collar member 51a which is adapted to fit about a bolt receiving opening 52a in the D-ring or guide or anchor member 52. The D-ring 52 is free to turn or pivot about the axis 49 located on the axis of the bolt shank 16b, as shown in FIG. 5. The D-ring is usually a stamped piece of sheet metal which has a belt receiving slot 52a which is covered by a plastic or slidable, low-friction material 52b about the slot. An upwardly projecting portion 52d on the D-ring member 52 has the pivot hole 52c therein for receiving the bolt shank 16a.

The outer cover portion or shell member 12 has a slot 62 formed in its bottom wall 12a to receive an upper portion 52d of the D-ring 52, as best seen in FIG. 4 where the outer cover member 12 is assembled onto the D-ring 52 and is held in position by the head 16a of the bolt 16. The bolt shank 16b is also inserted into a opening 56a in a collar member or bushing 56, which is located outwardly or behind the upstanding portion 54 of the guide anchor 52. Additionally, in this instance there is a button actuator member 58 which is slidably operable within the interior space of the D-ring cover 10 formed by the assembled cover members 12 and 14, and is mounted to the outer cover member 12 in a known manner. The button can be pushed to slide in a direction generally normal to the bolt axis 49 to operate a separate locking pin lifting it out of a rail opening in order to allow the D-ring assembly 10 to be raised or lowered. That is, the button 58 serves to allow the operator or the vehicle passenger to adjust the height of the shoulder belt on a vertical rail or track. The D-ring assembly 17 shown in FIG. 5 is merely illustrative of one of a number of different types of D-ring assemblies and is a commercially available product except for the tethered covers and, hence, it need not be described in detail any further. Manifestly, the present invention is not limited to this particular illustrated D-ring assembly. Further, rather than mounting the D-ring assembly to a height adjusting mechanism that is secured to a vehicle pillar, for instance, the D-ring assembly can be mounted directly to the pillar with only pivotal movement thereof provided. The final assembly of the D-ring assembly 17 to the outer cover member 12 is shown in FIGS. 6 and 7.

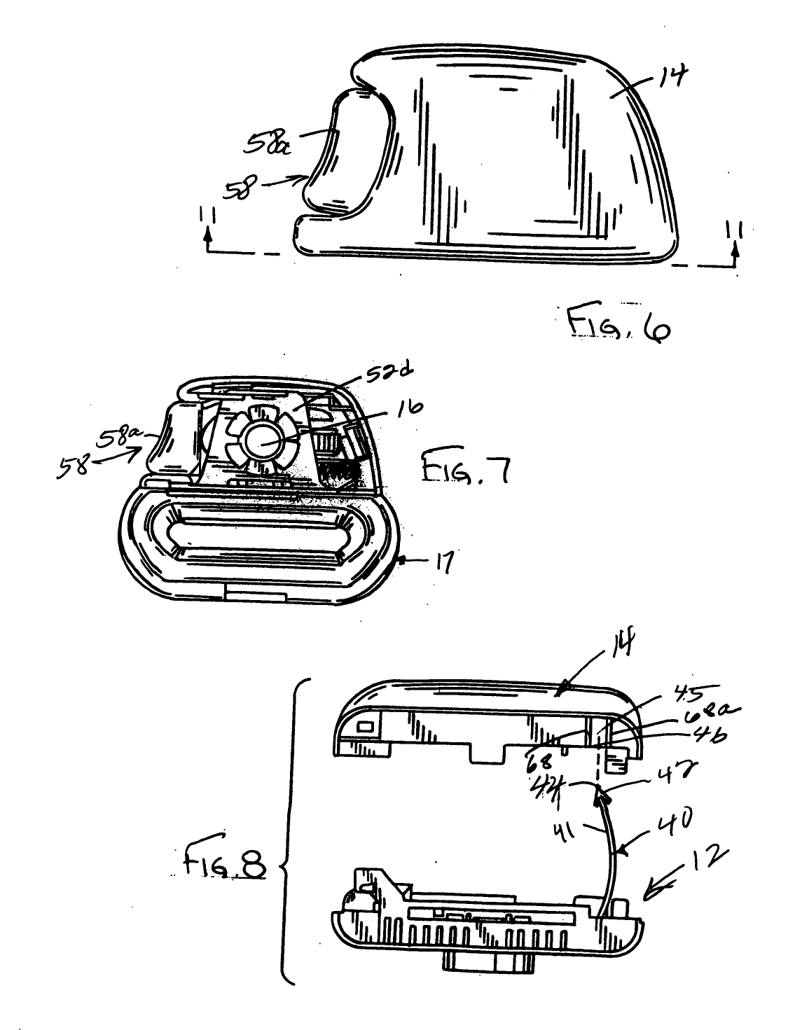

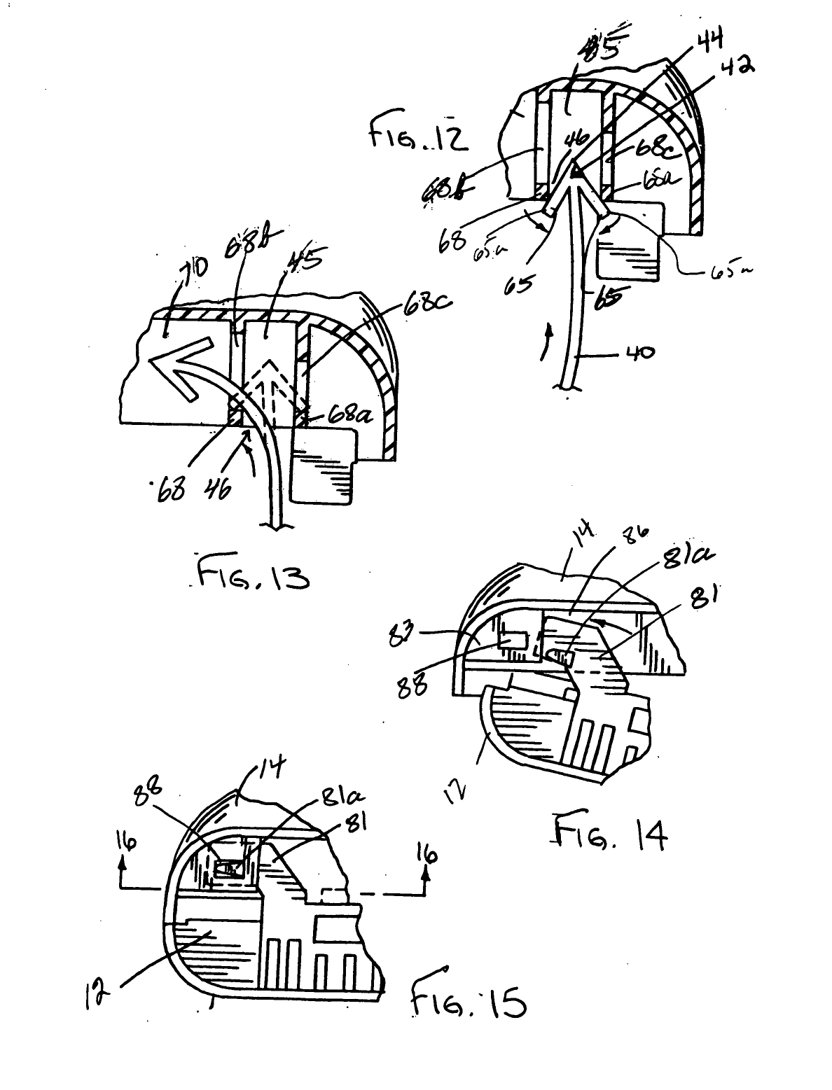

The illustrated and preferred tether 40, with its enlarged head 42, which is shown in FIGS. 8-13, comprises an elongated, thin piece or shaft 41 of plastic and the illustrated enlarged head 42 is arrow-shaped, although it could have shapes other than that of an arrow. The arrowhead shape is of particular use in that it performs a one-way insertion which allows it to be inserted as shown in FIG. 12 with opposite inclined sides 65 of the arrow being flexed or moved inwardly toward each other in order to pass through the narrower width opening 46 and then to expand returning to their original configuration as shown in the dotted lines in FIG. 13. As can be best understood from the illustrations in FIGS. 9-13, the sides of the arrowhead are deformed and flexed toward one another as they are inserted into a box opening 46 of a box 45 in the open, lower end of the inner cover member 14. The box 45 has a spaced pair of end walls 68 and 68a which define a space or an entry opening 46 which is narrower than the normal free expanded width of the inclined sides or portions 65 of the arrowhead, and specifically at the ends 65a of the sides. The inclined sides cam against the walls 68, 68a to be flexed together to pass between end walls 68 and 68a and then are allowed to expand as shown by the dotted line position in FIG. 13 where the arrow sides 65 expand back into openings 68b and 68c in the respective sidewalls 68 and 68b so as to be in interference therewith and substantially prevent withdrawal of the tether head 42 therefrom.

In accordance with the preferred embodiment, the tether 40 is hidden from view and is guided into a receptacle preferably in the form of an elongated side channel or slot 70 in the inner cover. The entrance to the receptacle slot 70 is the sidewall opening 68b, as shown in FIGS. 12 and 13 where the arrowhead 42 and following shaft 41 are directed to turn to the left with the thin shaft 41 bending as seen in FIG. 13 after having been inserted between the entrance walls 68 and 68a of the box 45. Then the tether is free to be slid into its hiding position within the receptacle slot 70 as the two cover portions are assembled as is clear from the assembly procedure illustrated in FIGS. 9-11. In FIG. 10 the tether arrow 42 is inserted and is moving to the left in the inner or upper cover portion 14 as it is being positioned over and adjacent to the outer or lower cover portion 12 prior to snap fitting or assembling the cover portions together. In FIG. 11 the tether is shown in the assembled position of the cover assembly 10 and is hidden from view.

As previously mentioned, the two partially assembled or loosely connected cover members 12 and 14 are snap fit together to complete the final assembly. In the illustrated embodiment, the snap fitting procedure includes a lateral sliding of the two cover portions relative to one another as indicated by the directional arrow in FIG. 10. The sliding motion is in a direction generally transverse to the axis 49. An upstanding latch projection or arm 81 on the outer cover member 12 has a laterally extending, small triangular-shaped ear or nib 81a which is moveable into a slot defined between the long receptacle wall 86 which guides the arrowhead of the cover to the left as shown in FIG. 10 and a laterally spaced, depending latch member 83 of the inner or upper cover member 14. As the ear 81 is moved into the slot it engages the narrow web portion 83a which is at the right end of the ear receiving window or opening 88. As the narrow portion 83a of the latch member 83 is cammed by the nib 81a to be flexed away from the receptacle wall 86a and to expand the slot to allow the ear 81a to pass into the slot, further sliding movement will bring the ear 81a into alignment with the window 88 and then the ear 81a is able to project into the window 88 in a snap-fit relation holding the cover member 12 at one end of the cover assembly 10 to the other cover member 14, as shown in FIGS. 15 and 16.

The opposite end of the cover assembly 10 is also latched by a hook-shaped latch member 90 on the outer or lower cover member 12 hooking onto a portion of the inner or upper cover member 14, as best seen in FIGS. 4 and 5. The illustrated hooked-shaped latch member 90, has an upper inclined portion 90a leading to an end projecting wall 90b to form a hook which will engage in hooking fashion into a portion of the inner cover member 14. When the inner and outer cover members are pushed together, the flexible latch member 90 will be pushed laterally and then is adapted to spring back to engage a shoulder on a rib portion formed on the inner cover member 14 to snap fit the right-hand end of the cover members 12 and 14 together. Thus, the cover members 12 and 14 are latched together in assembly against separation except with a force that would be sufficient to break apart the snap fit interlocking engagement at the two laterally spaced ends of the cover assembly. As explained previously, the shifting of the cover portion relative to one another causes the arrowhead 42 on the tether to slide along and within the receptacle 45 between the positions of FIGS. 10 and 11. In the FIG. 11 position, the tether is completely hidden from view.

In the illustrated form of FIG. 5, the tether has an integral connecting end 100, that integral with a sidewall of the outer cover member 12 and projecting generally straight outwardly therefrom. Manifestly, the tethered portion could be connected to a different portion of the outer cover or conversely, the tether could be integrally connected to the inner cover rather than to the outer cover and still fall within the purview of this invention.

In accordance with a further embodiment of the invention, as illustrated, for example, in FIG. 18, the tether 140 may be a separate molded piece from the cover members or shells 112 and 114 and may have identical enlarged heads, such as arrowheads 142, at opposite ends for connection to receiving receptacles or boxes 150 and 151 with the tether being positioned between the respective shell halves 112 and 114 when they are interlocked and snap-fit together into the final cover assembly. As shown in FIG. 19, the upper or inner cover member 114 may receive the arrowhead 142a through an opening leading to a receptacle which then guides the arrowhead to the right to have a portion within the upper cover portion 114. In a similar manner with respect to the lower or outer cover member 112, the lower arrowhead 142b of the tether is inserted through an opening and into a lower receptacle to move to the right within the receptacle to have the lower portion of the tether hidden when the two cover portions 112 and 114 are snap-fit together as by engaging latch portions 180 on the inner cover 114 with corresponding upwardly projecting portions 181 on the outer cover portion 112. In this instance the pair of projecting latches 180 are hook shaped and formed on the upper cover 114 and project downwardly as viewed in FIG. 19 for being received in the open slotted end with the hook end moving behind a shoulder wall 185 on the latch member 181 to hook or snap-fit the cover portions together in an assembled position.

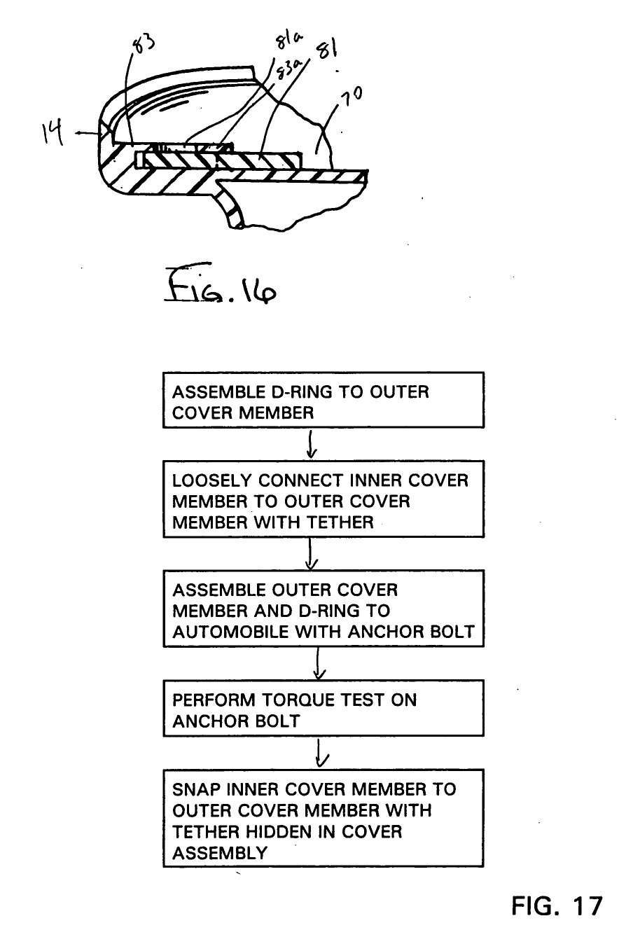

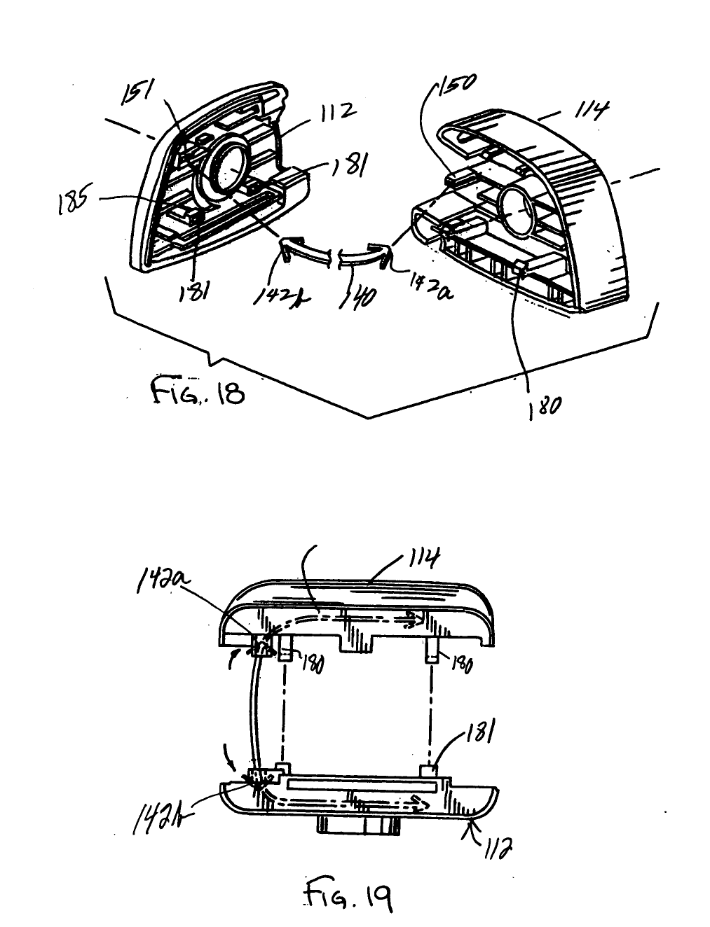

Turning now to FIG. 17 there is diagrammatically illustrated an assembly method, which includes assembling the D-ring to the lower or outer cover member 12 or 112. Thereafter, the assembled D-ring and outer cover member 12, 112 are connected to the vehicle with the anchor bolt 16. This may be before or after the inner cover member 14 or 114 is loosely tethered to the outer cover member 12 or 112. So tethered, the inner cover member 14 or 114 may be left dangling so that it is possible to leave the head of the bolt exposed and visible to perform torque testing while the inner cover member 14, 114 stays loosely connected in partial assembly to the outer cover member 12, 112. After testing and final assembly, the inner cover or shell 14, 114 is snap-fit to the outer or lower cover 12, 112. In the assembled position of the inner cover 14 or 114 to the outer cover 12 or 112, the tether will be hidden from view as shown in FIGS. 11 and 14.

The above-described embodiments are merely illustrative of the invention and other embodiments, changes or modifications can be made and still fall within the purview of the appended claims.

What is claimed is:

1. A cover assembly for a seat belt guide loop, the cover assembly comprising:
a first cover portion for securing to the cover to a vehicle structure;
a second cover portion for being assembled with the first cover portion; and
an elongate connector for connecting the first cover portion to the second cover portion.

2. A cover assembly in accordance with claim 1 wherein the elongate connector is flexible so that the flexible connector is adapted to be bent for positioning in a hidden position between the first cover portion and the second cover portion when they are assembled together.

3. A cover assembly in accordance with claim 1 wherein the elongate connector is a tether allowing the second portion to extend downwardly and dangle from the first portion exposing a bolt for adjustment or torque testing.

4. A cover assembly in accordance with claim 1 wherein the first and second cover portions are separate pieces and wherein the elongate connector is connected between the respectively separate cover portions.

5. A cover assembly in accordance with claim 1 wherein the cover portions are slidably interconnected, one relative to the other after the elongate connector is positioned between the respective cover portions.

6. A cover assembly in accordance with claim 1 wherein the elongate connector is integrally attached at one end to one of the cover portions and is manually secured to the other cover portion.

7. A cover assembly in accordance with claim 6 wherein there is a receiving opening on the first cover portion; and
an enlarged head on another free end of the elongate connector for being inserted into and through the opening on the second cover portion.

8. A cover assembly in accordance with claim 7 wherein the enlarged head is in the shape of an arrow.

9. A cover assembly in accordance with claim 1 wherein the elongate connector allows the second cover portion to be swung upwardly and slid laterally along the first cover portion when assembling the cover portions.

10. A seat belt guide loop assembly comprising:
a guide loop for slidably receiving a safety belt extending therethrough;
a bolt for securing the guide loop relative to the vehicle;
an outer cover portion for being secured by the bolt and leaving a head of the bolt exposed;
an inner cover portion for being assembled with the outer cover portion in order to cover the bolt head; and
a tether connecting the outer cover portion to the inner cover portion allowing the inner cover portion to dangle loosely with the bolt head exposed for tool access thereto prior to final assembly of the inner cover portion to the outer cover portion.

11. An assembly in accordance with claim 10 wherein the tether is adapted to be positioned in a hidden position between the outer cover portion and the inner cover portion when they are secured together.

12. A cover assembly in accordance with claim 10 comprising:
snap fit members on the inner and outer cover portions being interconnected at a final assembly of the cover portions.

13. A cover assembly for a seat belt guide loop, the cover assembly comprising:
a first cover portion for being secured to a vehicle structure;
a second cover portion for being secured to the first cover portion;
a tether for connecting the first cover portion to the second cover portion; and
an interior receptacle in at least one of said cover portions to receive the tether therein to hide the tether when the cover portions are assembled to one another.

14. A cover assembly in accordance with claim 13 wherein the tether is an elongate member allowing the second cover portion to extend downwardly and dangle from the first portion exposing a bolt for adjustment or torque testing.

15. A cover assembly in accordance with claim 13 wherein the first and second cover portions are each separately molded parts.

16. A cover assembly in accordance with claim 15 wherein the tether is integrally molded to one of the cover portions.

17. A cover assembly in accordance with claim 15 wherein the tether is a separately molded part.

18. A cover assembly in accordance with claim 13 wherein the cover portions are slidably interconnected, one relative to the other with the tether positioned in the receptacle as a result of the sliding between the cover portions.

19. A cover assembly in accordance with claim 13 wherein the receptacle is in the shape of an elongated slot in the first cover portion.
